(19) United States
(12) Patent Application Publication
(10) Pub. No.: US 2021/0299492 A1
(43) Pub. Date: Sep. 30, 2021

(54) Personal Fire-Fighting System

(71) Applicant: Teofilo Masri, La Crescenta, CA (US)

(72) Inventor: Teofilo Masri, La Crescenta, CA (US)

(21) Appl. No.: 17/037,658

(22) Filed: Sep. 29, 2020

Related U.S. Application Data
(63) Continuation-in-part of application No. 16/830,230, filed on Mar. 25, 2020, now abandoned.

(51) Int. Cl. A62C 31/00; A62C 27/00; A62C 3/02

(52) U.S. Cl. CPC A62C 31/005; A62C 3/0292; A62C 27/00

(57) ABSTRACT

A personal fire-fighting system can extinguish fires in order to save structures such as homes or business buildings. The personal fire-fighting system includes a frame, a water pump system, a suction hose, a high-trajectory nozzle, a rotor sprinkler, and a length-adjustable tube. The frame protects and holds the water pump system, the length-adjustable tube, and the rotor sprinkler in place. The water pump system drives water from the suction hose in order to be outputted by the rotor sprinkler. The suction hose is a fluid conduit between a body of water and the water pump system. The high-trajectory nozzle increases the trajectory angle of water that is outputted by the rotor sprinkler. The rotor sprinkler rotates and outputs streams of water in order to cover large areas. The length-adjustable tube allows the rotor sprinkler to output water at higher areas if needed.

The current application is a continuation-in-part (CIP) application of the U.S. non-provisional application Ser. No. 16/830,230 filed on Mar. 25, 2020.

### FIELD OF THE INVENTION

The present invention relates generally to fire-fighting systems. More specifically, the present invention is a personal fire-fighting system that can be used to extinguish fires to help save structures such as homes or business buildings.

### BACKGROUND OF THE INVENTION

Wildfires are becoming more common and accidental fires are occurring at a high rate. Individuals scramble to call their local fire department during these situations or to find a fire extinguisher to put out a fire, but the local fire department may take too long to save the structure and/or the fire extinguisher is not enough to put out the fire. There are existing inventions out there that could help in situations such as wildfires or accidental fire, but these existing inventions require grid provided electricity or water pressure in order to effectively function. There exists a need for a self-contained system that does not rely on grid provided electricity or water pressure.

It is therefore an objective of the present invention to provide a personal fire-fighting system that can be used to extinguish fires in order to save structures such as homes or business buildings. The personal fire-fighting system includes a gas-powered or electrically-powered water pump that uses water from an existing body of water such as a home pool, lake, river, or other similar reservoir. The personal fire-fighting system also includes a standalone, self-contained rotor sprinkler capable of spraying water at a distance of over 40 feet. The rotor sprinkler includes a uniquely designed nozzle which allows the rotor sprinkler to reach trajectory angles greater than 50 degrees. Thus, the personal fire-fighting system is able to shoot a water stream capable of reaching the roofline center by placing the personal fire-fighting system 15 to 20 feet away from the structure. The personal fire-fighting system allows individuals to turn the personal fire-fighting system on and walk away for a greater chance of saving the property without risking his or her own safety.

### BRIEF DESCRIPTION OF THE DRAWINGS

FIG. 1 is a left-side schematic diagram illustrating the overall system of the present invention.

FIG. 2 is a left-side schematic diagram illustrating the present invention with the length-adjustable in an extended state, one handle from the pair of handles, the gas tank, the gas motor, and the mechanical pump.

FIG. 3 is a right-side schematic diagram illustrating the present invention with the length-adjustable in an extended state, the other handle from the pair of handles, the electric power supply, the electric motor, and the mechanical pump.

FIG. 4 is a schematic diagram illustrating the electrical and electronic connections of the present invention.

FIG. 5 is a schematic diagram illustrating the details of the high-trajectory nozzle.

FIG. 6 is a left-side schematic diagram illustrating the supplemental outlet and the manual spraying hose.

FIG. 7 is a left-side schematic diagram illustrating the decorative enclosure.

FIG. 8 is a left-side perspective view of an exemplary embodiment of the present invention.

FIG. 9 is top left-side perspective view of an exemplary embodiment of the present invention.

FIG. 10 is a right-side perspective view of an exemplary embodiment of the present invention displaying the suction hose wrapped around the hose rack.

### DETAIL DESCRIPTIONS OF THE INVENTION

All illustrations of the drawings are for the purpose of describing selected versions of the present invention and are not intended to limit the scope of the present invention.

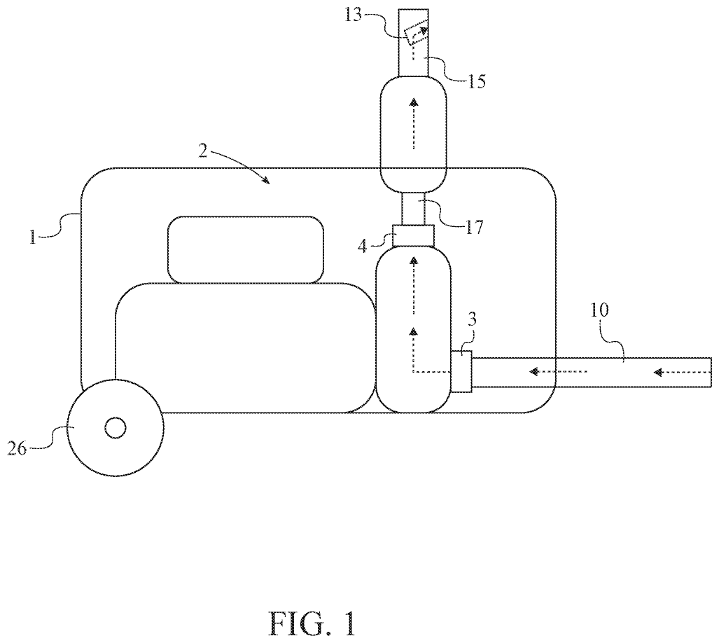

In reference to FIGS. 1 through 10, the present invention is a personal fire-fighting system that can be used to extinguish fires in order to save structures such as homes or business buildings. The present invention may comprise a frame 1, a water pump system 2, a suction hose 10, a high-trajectory nozzle 13, a rotor sprinkler 15, and a length-adjustable tube 17. The frame 1 protects and holds the water pump system 2, the length-adjustable tube 17, and the rotor sprinkler 15 in place. The water pump system 2 drives water from the suction hose 10 in order to be outputted by the rotor sprinkler 15. The suction hose 10 is a fluid conduit between a body of water such as, but not limited to, a home pool, lake, river, or other similar reservoir and the water pump system 2. The high-trajectory nozzle 13 is uniquely designed in order to increase the trajectory angle of water that is outputted by the rotor sprinkler 15. The rotor sprinkler 15 rotates and outputs streams of water in order to cover large areas. The length-adjustable tube 17 allows the rotor sprinkler 15 to output water at higher areas if needed.

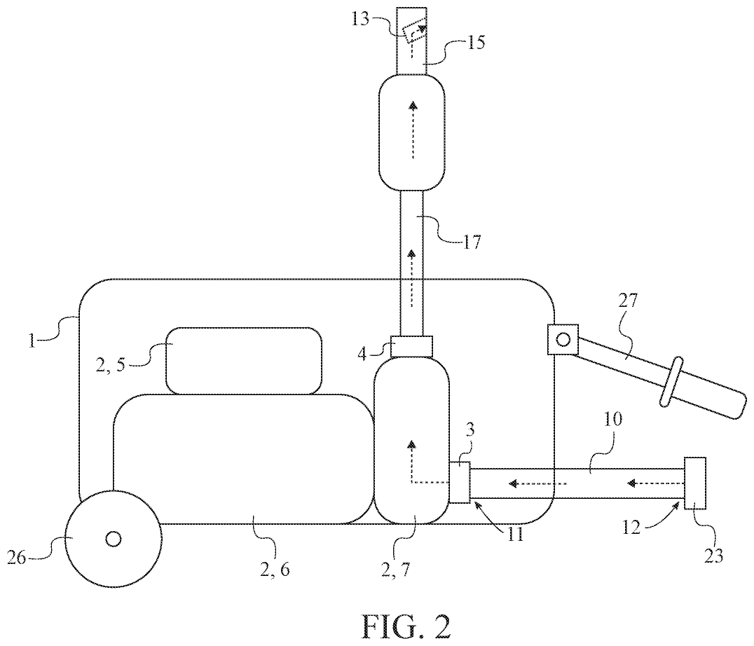

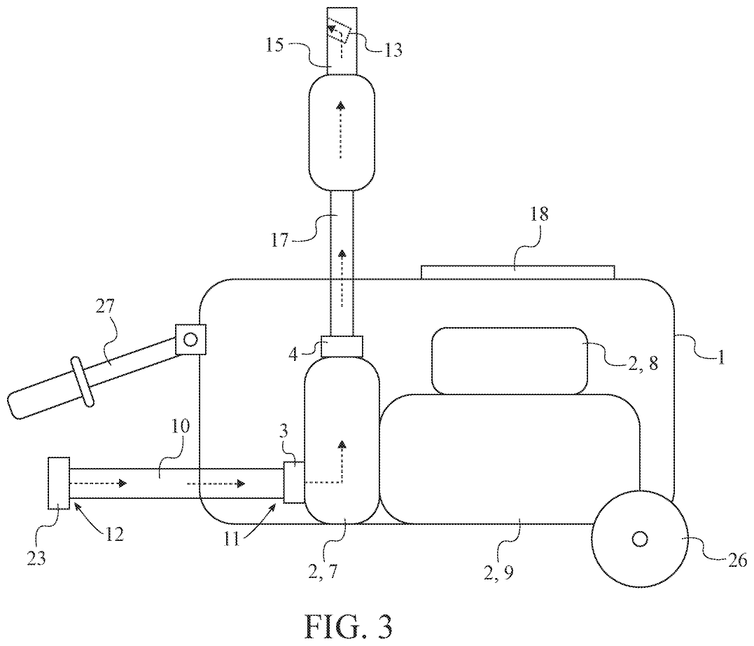

The general configuration of the aforementioned components allows the present invention to effectively extinguish fires in order to save structures such as homes or business buildings. With reference to FIG. 1, the water pump system 2 comprises a pump inlet 3 and a pump outlet 4. The water pump system 2 is mounted into the frame 1. The water pump system 2 is preferably mounted into the frame 1 through a set of brackets and fasteners. Thus, the frame 1 protects and holds the water pump system 2 in place. The length-adjustable tube 17 is mounted into the housing. The length-adjustable tube 17 is preferably mounted into the frame 1 through a set of u-shaped brackets and fasteners. Thus, the frame 1 protects and holds the length-adjustable tube 17 in place. However and with reference to FIGS. 2 and 3, the length-adjustable tube 17 is mounted through a means that allows the length-adjustable tube 17 to extend out of the frame 1 if needed. The length-adjustable tube 17 may be any type of telescopic mechanism such as, but not limited, using multiple tubes that are slidably engaged to each other or by using foldable tube joints. The rotor sprinkler 15 is terminally mounted to the length-adjustable tube 17, opposite to the frame 1. This arrangement offsets the rotor sprinkler 15 at a higher elevation than the rest of the present invention so that the rotor sprinkler 15 is better able to project water onto an enflamed structure. The suction hose 10 is in fluid communication with the pump inlet 3. This arrangement allows water to be driven from a body of water, through the suction hose 10, and into the water pump system 2. The pump outlet 4 is in fluid communication with the rotor sprinkler 15 through the length-adjustable tube 17. This arrangement allows water to be driven from the water pump system 2, through the length-adjustable tube 17, and out of the rotor sprinkler 15. The high-trajectory nozzle 13 is operatively integrated into the rotor sprinkler 15 and is consequently used to direct water being sprayed out of the rotor sprinkler 15. In further detail, the high-trajectory nozzle 13 is designed to alter the trajectory of the water outputted from the rotor sprinkler 15. This allows the rotor sprinkler 15 to spray water high enough to reach to roofline center of enflamed structures.

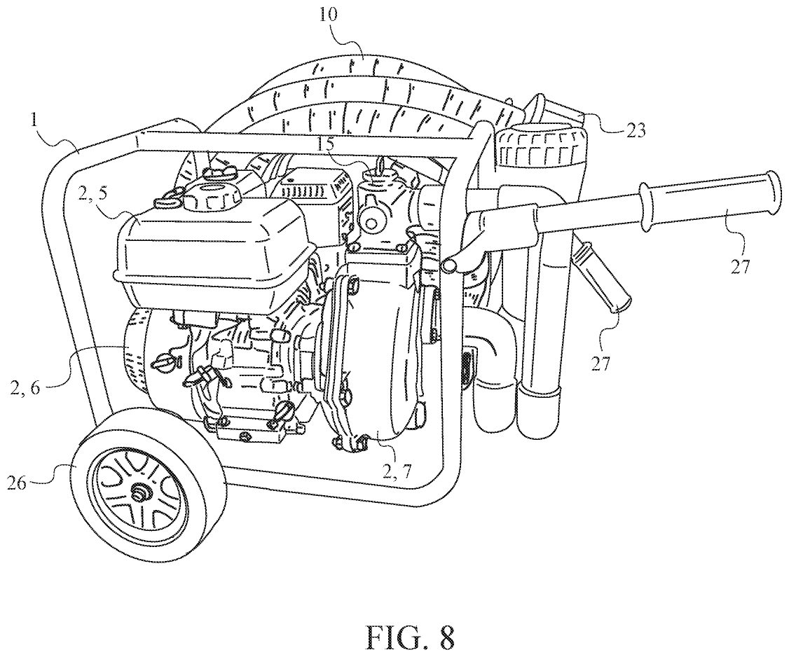

In order for the water pump system 2 to effectively drive water from the suction hose 10 to be outputted by the rotor sprinkler 15 and with reference to FIGS. 2 and 8, the water pump system 2 may further comprise a gas tank 5, a gas motor 6, and a mechanical pump 7. The gas tank 5 is in fluid communication with the gas motor 6. Thus, the gas tank 5 provides fuel to the gas motor 6 in order for the gas motor 6 to operate. The gas motor 6 is operatively coupled to mechanical pump 7 and is consequently used to actuate the mechanical pump 7. Thus, the mechanical pump 7 is able to drive water from the suction hose 10 in order to be outputted by the rotor sprinkler 15.

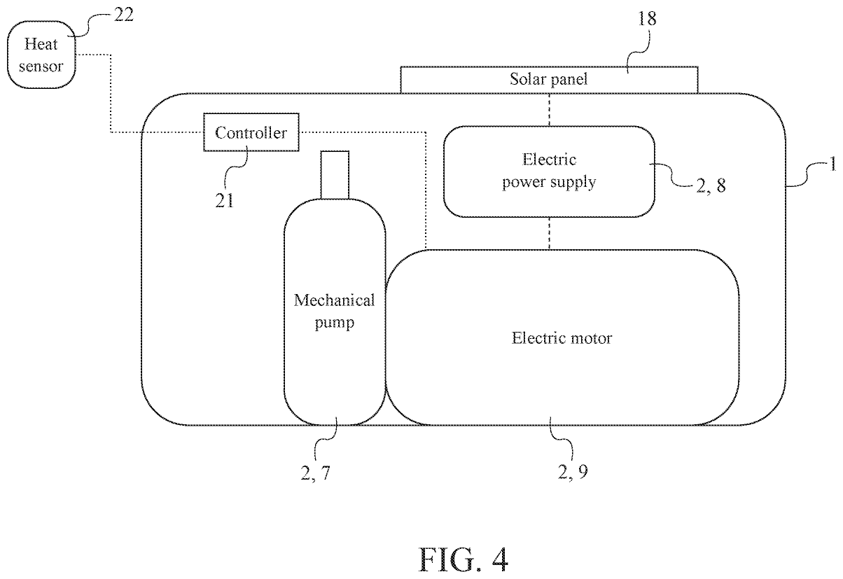

Alternatively and with reference to FIG. 3, the water pump system 2 may further comprise an electric power supply 8 and an electric motor 9. With reference to FIG. 4, the electric power supply 8 is electrically connected to the electric motor 9. Thus, electrical power can be supplied to the electric motor 9 from the electric power supply 8. The electric power supply 8 may be any type of electric power source such as, but not limited to, a rechargeable battery system. The electric motor 9 is operatively coupled to the mechanical pump 7 and is consequently used to actuate to the mechanical pump 7. Thus, the mechanical pump 7 is able to drive water from the suction hose 10 in order to be outputted by the rotor sprinkler 15. Further, the present invention may further comprise at least one solar panel 18. The at least one solar panel 18 is preferably mounted onto the frame 1 through a set of brackets and fasteners. The at least one solar panel 18 is electrically connected to the electric power supply 8 through a solar controller 21. Thus, the at least one solar panel 18 can be used to electrically charge the electric power supply 8.

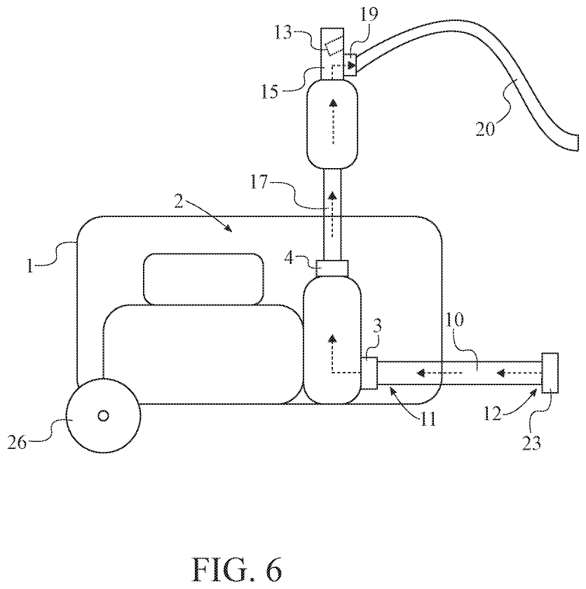

With reference to FIG. 6, the present invention may further comprise a supplemental outlet 19 and a manual spraying hose 20 if a user desires to manually extinguish a fire using the present invention. The supplemental outlet 19 is positioned adjacent to the rotor sprinkler 15. This arrangement positions the supplemental outlet 19 in order to be easily accessible to a user. The pump outlet 4 is in fluid communication with the supplemental outlet 19. This allows the water pump system 2 to drive water from the suction hose 10 to the supplemental outlet 19. The supplemental outlet 19 is in fluid communication with the manual spraying hose 20. This allows water to flow from the supplemental outlet 19 in order to be outputted by the manual spraying hose 20. Thus, a user can manually extinguish a fire by spraying water through the manual spraying hose 20.

In order for the present invention to operate autonomously and with reference to FIG. 4, the present invention may further comprise a controller 21 and at least one heat sensor 22. The controller 21 is preferably mounted onto the frame 1 by a bracket and fasteners. The at least one heat sensor 22 is positioned offset from the frame 1. This arrangement positions the at least one heat sensor 22 in order to effectively to detect high temperatures and therefore, detect a wildfire or accidental fire occurring inside or outside a structure. The at least one heat sensor 22 is communicably coupled to the controller 21. This allows data to be relayed from the at least one heat sensor 22 to the controller 21. The controller 21 is electronically connected to the water pump system 2. This allows the water pump system 2 to be autonomously activated by the controller 21 if the at least one heat sensor 22 detects a fire.

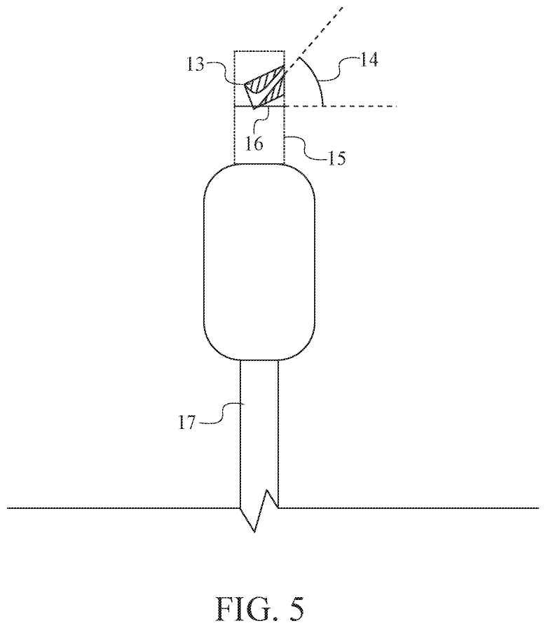

With reference to FIG. 5, the following arrangement of components allows the rotor sprinkler 15 to spray water up to the roofline center of a structure through use of the high-trajectory nozzle 13. The length-adjustable tube 17 is positioned normal to a transverse plane 16 of the rotor sprinkler 15. This arrangement causes water to be outputted at an angle by the rotor sprinkler 15. The rotor sprinkler 15, as a standalone unit, outputs water at a maximum trajectory angle of 30 degrees from the ground with a throw distance of about 40 feet. Thus, a maximum height apex of about 11.5 feet is reached which is not sufficient to reach average roof centerline height of single-story building which is approximately 17 feet. However, the high-trajectory nozzle 13 is oriented at a high-trajectory angle 14 with the transverse plane 16 of the rotor sprinkler 15. This arrangement increases the trajectory angle of the water being outputted by the rotor sprinkler 15. In order to optimally increase the trajectory angle of the water being outputted by the rotor sprinkler 15, the high-trajectory angle 14 is greater than 30 degrees. Thus, the rotor sprinkler 15 can spray water up to the roofline center of a structure through use of the high-trajectory nozzle 13. In further detail, the rotor sprinkler 15 in combination with the high-trajectory nozzle 13 outputs water up at trajectory angle around 50 degrees from the ground with a throw distance of about 34 feet. Thus, a height apex of 20 feet is reached through use of the high-trajectory nozzle 13.

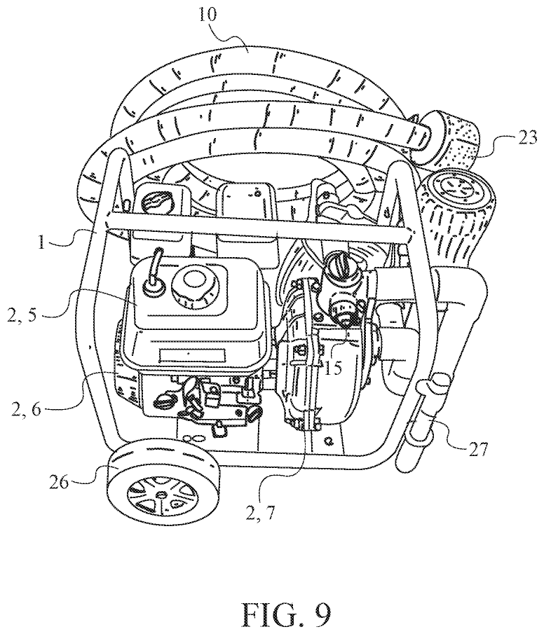

In order to prevent any pressure buildup due to any debris flowing into the suction hose 10 and with reference to FIGS. 2 and 9, the present invention may further comprise a suction filter 23. The suction hose 10 comprises a distal hose end 12 and a proximal hose end 11. The proximal hose end 11 is hermetically connected to the pump inlet 3. This arrangement creates a water-tight seal between the suction hose 10 and the water pump system 2 and allows the water pump system 2 to drive water through the suction hose 10. The suction filter 23 is attached across the distal hose end 12. Thus, the suction filter 23 prevents pressure buildup by preventing any debris from flowing into and through the suction hose 10.

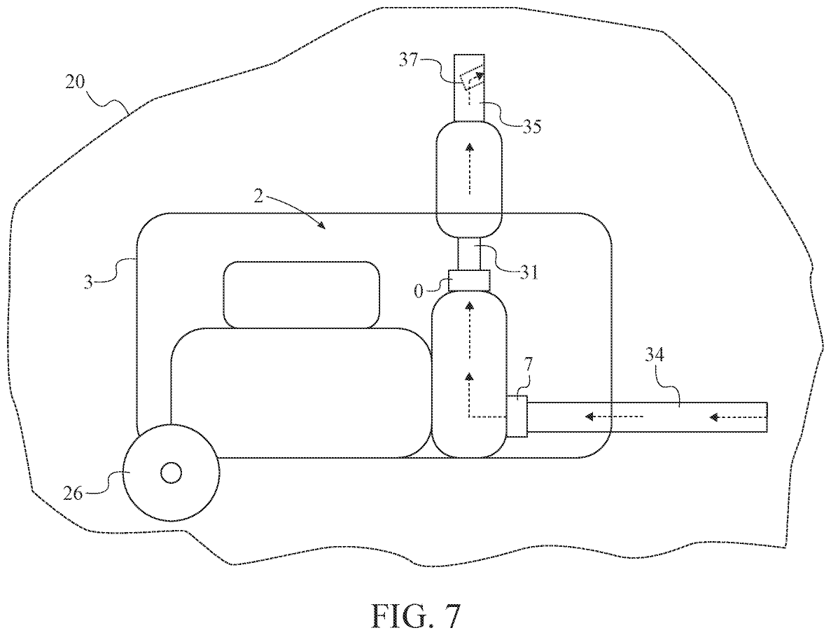

In order to decoratively conceal the present invention when not in use and with reference to FIG. 7, the present invention may further comprise a decorative enclosure 24. The frame 1, the water pump system 2, the suction hose 10, the high-trajectory nozzle 13, the rotor sprinkler 15, and the length-adjustable tube 17 are positioned within the decorative enclosure 24. Thus, the decorative enclosure 24 conceals the frame 1, the water pump system 2, the suction hose 10, the high-trajectory nozzle 13, the rotor sprinkler 15, and the length-adjustable tube 17. The decorative enclosure 24 may be any type of enclosure such as, but not limited to, a rock-like structure, a table, bench, wicker accent piece, or other decorative item. This allows the present invention to remain on a property ready to be used while looking like a piece of decorative accent or furniture.

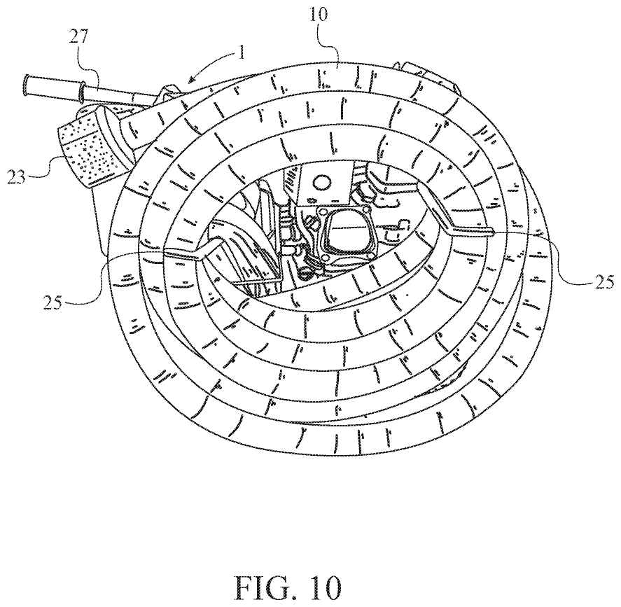

In order to store the suction hose 10 when the present invention is not in use and with reference to FIG. 10, the present invention may further comprise a hose rack 25. The hose rack 25 is preferably a pair of hooks mounted adjacent to the frame 1 through a set of fasteners. The suction hose 10 is wrapped around the hose rack 25. Thus, the suction hose 10 can be securely stored when the present invention is not in use.

In order to easily transport or move the present invention and with reference to FIGS. 2 and 3, the present invention may further comprise a pair of wheel assemblies 26 and a pair of handles 27. The pair of wheel assemblies 26 is mounted adjacent to the frame 1, opposite to the length-adjustable tube 17. Thus, a user can roll the present invention across a surface through the pair of wheel assemblies 26. The pair of handles 27 is mounted adjacent to the frame 1, opposite the pair of wheel assemblies 26, which allows a user to leverage the pair of handles 27 and to tilt the present invention about the pair of wheel assemblies 26. Thus, the user can easily access and grip the pair of handles 27 in order to pull the present invention across a surface with the pair of wheel assemblies 26. Further, the pair of handles 27 is preferably mounted through the use of brackets and fasteners in a manner that allows the pair of handles 27 to be folded towards the frame 1 when the present invention is not in use. The present invention may further include a brake stand. The brake stand prevents the present invention from rolling across a surface when not in use.

Although the invention has been explained in relation to its preferred embodiment, it is to be understood that many other possible modifications and variations can be made without departing from the spirit and scope of the invention as hereinafter claimed.

What is claimed is:

1. A personal fire-fighting system comprises:
a frame;
a water pump system;
a suction hose;
a high-trajectory nozzle;
a rotor sprinkler;
a length-adjustable tube;
the water pump system comprises a pump inlet and a pump outlet;
the water pump system being mounted within the frame;
the length-adjustable tube being mounted into the frame;
the rotor sprinkler being terminally mounted to the length-adjustable tube, opposite to the frame;
the suction hose being in fluid communication with the pump inlet;
the pump outlet being in fluid communication with the rotor sprinkler through the length-adjustable tube; and
the high-trajectory nozzle being operatively integrated into the rotor sprinkler, wherein the high-trajectory nozzle is used to direct water being sprayed out of the rotor sprinkler.

2. The personal fire-fighting system as claimed in claim 1 comprises:
the water pump system comprises a gas tank, a gas motor, and a mechanical pump;
the gas tank being in fluid communication with the gas motor; and
the gas motor being operatively coupled to the mechanical pump, wherein the gas motor is used to actuate the mechanical pump.

3. The personal fire-fighting system as claimed in claim 1 comprises:
the water pump system comprises an electric power supply, an electric motor, and a mechanical pump;
the electric power supply being electrically connected to the electrical motor; and
the electric motor being operatively coupled to the mechanical pump, wherein the electric motor is used to actuate the mechanical pump.

4. The personal fire-fighting system as claimed in claim 3 comprises:
at least one solar panel;
the at least one solar panel being mounted onto the frame; and
the at least one solar panel being electrically connected to the electrical power supply.

5. The personal fire-fighting system as claimed in claim 1 comprises:
a supplemental outlet;
a manual spraying hose;
the supplemental outlet being positioned adjacent to the rotor sprinkler;
the pump outlet being in fluid communication with the supplemental outlet; and
the supplemental outlet being in fluid communication with the manual spraying hose.

6. The personal fire-fighting system as claimed in claim 1 comprises:
a controller;
at least one heat sensor;
the controller being mounted onto the frame;
the at least one heat sensor being positioned offset from the frame;
the at least one heat sensor being communicably coupled to the controller; and
the controller being electronically connected to the water pump system.

7. The personal fire-fighting system as claimed in claim 1 comprises:
the length-adjustable tube being positioned normal to a transverse plane of the rotor sprinkler;
the high-trajectory nozzle being oriented at a high-trajectory angle with the transverse plane of the rotor sprinkler; and
the high-trajectory angle being greater than 30 degrees.

8. The personal fire-fighting system as claimed in claim 1 comprises:
a suction filter;
the suction hose comprises a distal hose end and a proximal hose end;
the proximal hose being hermetically connected to the pump inlet; and
the suction filter being mounted across the distal hose end.

9. The personal fire-fighting system as claimed in claim 1 comprises:
a decorative enclosure; and
the frame, the water pump system, the suction hose, the high-trajectory nozzle, the rotor sprinkler, and the length-adjustable tube being positioned within the decorative enclosure.

10. The personal fire-fighting system as claimed in claim 1 comprises:
a hose rack;
the hose rack being mounted adjacent to the frame; and
the suction hose being wrapped around the hose rack.

11. The personal fire-fighting system as claimed in claim 1 comprises:
a pair of wheel assemblies;
a pair of handles;
the pair of wheel assemblies being mounted adjacent to the frame, opposite the length-adjustable tube; and
the pair of handles being mounted adjacent to the frame, opposite the pair of wheel assemblies.

12. A personal fire-fighting system comprises:
a frame;
a water pump system;
a suction hose;
a high-trajectory nozzle;
a rotor sprinkler;
a length-adjustable tube;
a controller;
at least one heat sensor;
the water pump system comprises a pump inlet and a pump outlet;
the water pump system being mounted within the frame;
the length-adjustable tube being mounted into the frame;
the rotor sprinkler being terminally mounted to the length-adjustable tube, opposite to the frame;
the suction hose being in fluid communication with the pump inlet;
the pump outlet being in fluid communication with the rotor sprinkler through the length-adjustable tube;
the high-trajectory nozzle being operatively integrated into the rotor sprinkler, wherein the high-trajectory nozzle is used to direct water being sprayed out of the rotor sprinkler;
the controller being mounted onto the frame;
the at least one heat sensor being positioned offset from the frame;
the at least one heat sensor being communicably coupled to the controller; and
the controller being electronically connected to the water pump system.

13. The personal fire-fighting system as claimed in claim 12 comprises:
the water pump system comprises a gas tank, a gas motor, and a mechanical pump;
the gas tank being in fluid communication with the gas motor; and
the gas motor being operatively coupled to the mechanical pump, wherein the gas motor is used to actuate the mechanical pump.

14. The personal fire-fighting system as claimed in claim 12 comprises:
at least one solar panel;
the water pump system comprises an electric power supply, an electric motor, and a mechanical pump;
the electric power supply being electrically connected to the electrical motor; and
the electric motor being operatively coupled to the mechanical pump, wherein the electric motor is used to actuate the mechanical pump.
the at least one solar panel being mounted onto the frame; and
the at least one solar panel being electrically connected to the electrical power supply.

15. The personal fire-fighting system as claimed in claim 12 comprises:
a supplemental outlet;
a manual spraying hose;
the supplemental outlet being positioned adjacent to the rotor sprinkler;
the pump outlet being in fluid communication with the supplemental outlet; and
the supplemental outlet being in fluid communication with the manual spraying hose.

16. The personal fire-fighting system as claimed in claim 12 comprises:
the length-adjustable tube being positioned normal to a transverse plane of the rotor sprinkler;
the high-trajectory nozzle being oriented at a high-trajectory angle with the transverse plane of the rotor sprinkler; and
the high-trajectory angle being greater than 30 degrees.

17. The personal fire-fighting system as claimed in claim 12 comprises:
a suction filter;
the suction hose comprises a distal hose end and a proximal hose end;
the proximal hose being hermetically connected to the pump inlet; and
the suction filter being mounted across the distal hose end.

18. The personal fire-fighting system as claimed in claim 12 comprises:
a decorative enclosure; and
the frame, the water pump system, the suction hose, the high-trajectory nozzle, the rotor sprinkler, and the length-adjustable tube being positioned within the decorative enclosure.

19. The personal fire-fighting system as claimed in claim 12 comprises:
a hose rack;
the hose rack being mounted adjacent to the frame; and
the suction hose being wrapped around the hose rack.

20. The personal fire-fighting system as claimed in claim 12 comprises:
a pair of wheel assemblies;
a pair of handles;
the pair of wheel assemblies being mounted adjacent to the frame, opposite the length-adjustable tube; and
the pair of handles being mounted adjacent to the frame, opposite the pair of wheel assemblies.
